(19) United States
(12) Patent Application Publication
(10) Pub. No.: US 2006/0039740 A1
(43) Pub. Date: Feb. 23, 2006

(54) Holding sleeve system

(76) Inventor: Brandon Robert Mackay, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/956,388

(22) Filed: Oct. 1, 2004

Related U.S. Application Data
(63) Continuation-in-part of application No. 29/211,800, filed on Aug. 20, 2004.

(51) Int. Cl. B05C 1/00

(52) U.S. Cl. 401/131

(57) ABSTRACT

A holding sleeve system includes: (a) a holding sleeve configured to receive a first object therein; (ii) a coupler connected to the holding sleeve; and (ii) an attachment member selectively coupled to the coupler, the attachment member selectively coupling to a second object. One or both sleeve ends can have (i) a first terminus; and (ii) a second terminus. The first terminus extends further away from the center of the sleeve than the second terminus, such that the first terminus of the first end can cover and protect a portion (e.g., threads of a lip balm container) of a first object while another portion is exposed outside the sleeve and can be contacted by a user.

### CROSS-REFERENCE TO RELATED APPLICATIONS

This patent application is a continuation-in-part of U.S. Design patent application Ser. No. 29/211,800 filed Aug. 20, 2004, entitled “Lanyard Connector,” to Brandon Mackay, which is incorporated herein in its entirety by reference.

### BACKGROUND OF THE INVENTION

1. The Field of the Invention

This invention is in the field of holding sleeves having an attachment connected thereto.

2. The Related Technology

Holding sleeves have been developed for use in holding articles such as bottles and other objects. The sleeves are comprised of a cylindrical sleeve having a clip connected thereto. The sleeve holds the bottle or other container therein while the clip can be connected to another object for convenient storage or transport.

The sleeve can also be used to hold objects such as a container of lip balm, e.g., CHAPSTICK® lip balm, therein. Unfortunately, the sleeves are commonly configured such that when the sleeve holds a lip balm container, the adjustment threads of the lip balm container (which can be turned to press lip balm out of the container) are exposed outside the sleeve.

Hence, when the sleeve and lip balm container mounted therein are exposed to common environmental factors, such as by being placed adjacent or inside a user's pocket or coupled to a user's belt loop, it is possible for the threaded adjustment mechanism to be inadvertently moved. Enough inadvertent movement can force the lip balm out of the container in an undesired fashion. Furthermore, exposure of the lid of the lip balm container to such environmental factors can cause the lid to inadvertently move and possibly expose the lip balm to the environment. In either of these scenarios, the lip balm contained within the lip balm container can potentially be exposed outside the container or pressed within the lid such that when the lid is removed a substantial amount of lip balm is pressed onto or within the lid or can even seep outside of the lid in an unsightly, messy and inconvenient fashion. Furthermore, typical holding sleeves provide only a single mechanism for attaching the sleeve to an object.

### BRIEF SUMMARY OF THE INVENTION

These problems in the art can be overcome, at least in part, through the use of a holding sleeve system of the present invention. A holding sleeve system of the present invention comprises: (i) a holding sleeve assembly comprising (A) a holding sleeve configured to receive a first object (such as a lip balm container) therein; and (B) a coupler connected to the holding sleeve; and (ii) one or more attachment members selectively coupled to the coupler of the holding sleeve assembly. The attachment member selectively couples to a second object, such as a belt loop so that a user can conveniently access the lip balm during recreation, work, or other activity. A variety of different attachment members can be selectively coupled to the coupler, thereby providing the user with a variety of choices and options and enabling a number of different attachment members to be employed in conjunction with a single sleeve.

Rather than having flat sleeve ends, in one embodiment, at least the first end, and, in one embodiment, both the first and second ends of the sleeve have (a) a first terminus, i.e., terminal portion of material; and (b) a second terminus. The first terminus at an end extends further away from the center of the sleeve than the second terminus at that end, such that the first terminus of the first end can cover a portion of an object while another portion of the object is exposed outside the sleeve so as to be contacted by a user. This can be achieved, for example, by having slanted sleeve ends wherein a lower portion of each sleeve extends further than an upper portion of each sleeve end.

Thus, one portion of the threads on a lip balm container can be covered by a terminal portion of material such that the threads can be protected at least somewhat from inadvertant movement, while the uncovered, exposed portion of the threads can be contacted by a user in the event the user desires to move the threads to move some lip balm out.

Similarly, one portion of the lid of the lip balm container can be covered by a terminal portion of material such that the lid can be protected at least somewhat from inadvertent movement. The uncovered, exposed portion of the lid, however can be contacted by a user in the event the user desires to remove the lid.

The outwardly extending material can extend outwardly from one or both ends of the sleeve. The outwardly extending material can prevent environmental factors such as contact within a user's pocket or during movement or transport by a user from affecting the threaded adjustment mechanism and/or the lid of a lip balm container.

The material extending from one or more ends of the sleeve may be in the form of a slanted sleeve end, a circular sleeve end, a rounded sleeve end, one or more ends having material jutting irregularly therefrom, material extending outwardly in a saw tooth configuration, or in a variety of configurations which provide material extending from one portion of an end while leaving another portion of an end without such outwardly extending material. The ends of the sleeve may be symmetrical or may have different configurations, e.g., one side being slanted while the other side is rounded.

The coupler and attachment members are configured such that a variety of different attachment members can be selectively coupled to the coupler. The coupler can be connected to the holding sleeve in a variety of different manners, such as through the use of a lanyard. The lanyard may have the ends thereof sewn into a seam of the sleeve, with the coupler mounted between the ends, for example. In such an embodiment, the lanyard sleeve may be located at one or both ends of the sleeve or may for example be located in the center of the sleeve such that the sleeve can hang downwardly in a symmetrical fashion.

A variety of different attachment members can be selectively coupled to the coupler, the attachment members selectively coupling to an object such as a belt loop, backpack, clothing or other accessory. Examples of such attachment members include a hook, clip, o-ring, alligator clip, or a variety of other configurations that allow another object such as a belt loop, lanyard, display rack, or other device to be connected to the holding sleeve system. Thus, the coupler may be a universal coupler that selectively couples to a variety of different attachment members, each of which have mating structures configured to selectively mount to the coupler.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a holding sleeve system of the present invention comprising (i) a plurality of attachment members; and (ii) a holding sleeve assembly comprising a coupler connected to a sleeve, the plurality of attachment members being selectively coupled to the coupler; the sleeve of the holding sleeve assembly has a lip balm container therein and has slanted ends that can protect a selected portion of the container;

FIG. 2 is a side view of the holding sleeve system of FIG. 1 being shown mounted on a belt loop. A broken longitudinal line identifies a longitudinal axis of the sleeve while transverse broken lines identify the opposing ends of the sleeve from which, in one portion of each end (i.e., the bottom portion), additional material extends away from the transverse axis of each end;

FIG. 3 is another side view of the holding sleeve assembly of FIG. 1 with a lip balm container having a threaded adjustment portion mounted in the sleeve such that the lower terminus of an end contacts the threaded portion, so as to protect the threads at least somewhat against movement while an upper terminal portion of the end does not contact the threaded portion. Thus, the uncovered, exposed threaded portion can be grasped and moved by a user;

FIG. 4 is another side view of the holding sleeve assembly of FIG. 1 with a lip balm container having a portion of a lid mounted in the sleeve such that the lower terminus of an end contacts the lid, so as to protect the lid at least somewhat against movement while an upper terminal portion of the end does not contact the lid. Thus, the uncovered, exposed lid portion can be grasped and moved by a user. In one embodiment, the opposing side view is a mirror image of the side view shown in FIG. 4.

FIG. 5 shows a top view of the holding sleeve assembly of FIGS. 4 and 1;

FIG. 6 shows an end view of the holding sleeve assembly of FIGS. 4 and 1, the opposing end view being the mirror image thereof;

FIG. 7 shows a bottom view of the holding sleeve assembly of FIGS. 4 and 1;

FIG. 8 shows a side view of a holding sleeve assembly having a portion of material extending outwardly at each of the ends of the sleeve in a curved shape. In one embodiment, the opposing side view is a mirror image of the side view shown in FIG. 8.

FIG. 9 shows a side view of an alternative holding sleeve assembly having portions of material extending outwardly at each of the ends in different shapes.

FIG. 10 is a perspective view of a holding sleeve assembly of the present invention comprising a coupler connected to a sleeve; the sleeve of the holding sleeve assembly has a lip balm container therein and has rounded ends that can protect a selected portion of the container;

FIG. 11 shows a top view of a circular piece of material used in forming holding sleeve of FIG. 10;

FIG. 12 shows an end view of the holding sleeve assembly of FIG. 10, the opposing end view being the mirror image thereof;

FIG. 13 shows a side view of the holding sleeve assembly of FIG. 10, the opposing side view being the mirror image thereof;

FIG. 14 shows a top view of the holding sleeve assembly of FIG. 10;

FIG. 15 shows a bottom view of the holding sleeve assembly of FIG. 10.

### DETAILED DESCRIPTION OF THE PREFERRED EMBODIMENTS

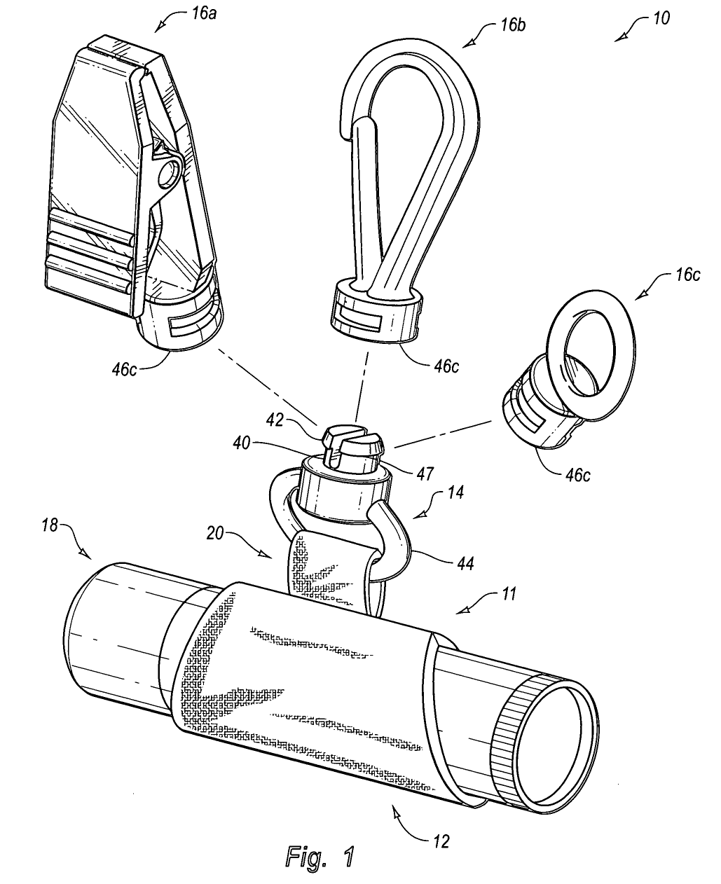

FIG. 1 is a perspective view of a holding sleeve system 10 of the present invention. Holding sleeve system 10 comprises (i) a holding sleeve assembly 11 comprising: (A) a holding sleeve 12 configured to selectively receive and retain an object therein; and (B) a coupler 14 connected to holding sleeve 12; and (ii) at least one attachment member 16a selectively coupled to coupler 14 of holding sleeve assembly 12. Attachment member 16A selectively couples to another object, such as a belt loop for convenient access by a user during work, recreation or other activity.

FIG. 1 shows that system 10 comprises a plurality of attachment members 16a-16c, each of which are configured to be selectively coupled to universal coupler 14, thereby providing selection, options and choice for a user, depending upon a desired application.

The object shown selectively received and retained within sleeve 12 in FIG. 1 is a container 18, such as a lip balm container, although a variety of other containers such as bottles, pens, elongate structures, or other objects can be selectively received and retained within sleeve 12.

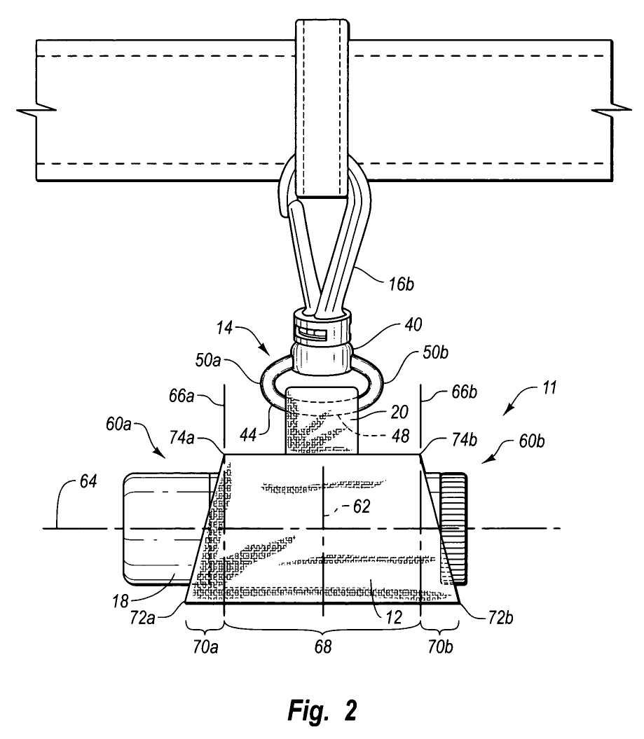

The objects to which attachment members 16a-c may selectively couple include a variety of different objects depending upon the location a user desires to place system 10, such as a belt loop (FIG. 2), backpack, another article of equipment or clothing, a neck lanyard, store shelf, vehicle (e.g., a bicycle or within a car), or a variety of other objects worn or contacted by a user for convenient access to lip balm or other materal during recreation, work, or other activity. Coupler 14 of holding sleeve assembly 11 is selectively, rotatably coupled to at least one of a plurality of different attachment members 16a-c, which selectively couple to such an object.

Coupler 14 is connected to sleeve 12 through a connector 20 of holding sleeve assembly 11. Connector 20 may be in the form of a variety of different connectors. In one embodiment, connector 20 comprises a lanyard 20 having first and second opposing ends. The opposing ends of the lanyard 20 may be sewn into the seam of sleeve 12.

As indicated above, coupler 14, also referred to as a lanyard connector, can be conveniently, selectively, rotatably coupled to one of a variety of different attachment members, examples of which are shown at 16a-c in FIG. 1. Coupler 14 is also described in U.S. Design patent application Ser. No. 29/211,800, filed on Aug. 20, 2004, entitled “Lanyard Connector,” to Brandon Mackay, which is incorporated herein by reference, and which shows perspective, side, top, bottom, and left/right views thereof.

One major advantage of coupler 14 is that it enables a variety of different attachment members, e.g. attachment members 16a-c to be selectively coupled to coupler 14, as disclosed in U.S. Pat. No. 6,711,785, which is incorporated herein by reference, thereby enabling a variety of different attachment members, e.g. 16a-c, to be linked to sleeve 12. By enabling the user to link a variety of different attachment members, e.g. 16a-c, to sleeve 12, as depicted in FIG. 1, a user can use a sleeve 12 with a variety of different attachment members. Furthermore, if a user initially orders a sleeve 12 having a first attachment such as an alligator clip, shown at 16a, then changes his or her mind and decides to switch to an o-ring, shown at 16c, the user can readily change to the o-ring 16c without having to pay for a new sleeve or coupler.

With reference now to FIGS. 1 and 2, coupler 14 comprises a body 40 having a split neck connection portion 42 coupled to a distal end thereof and having a substantially oval-shaped loop member 44 coupled to a proximal end thereof. Body 40 is cylindrical in shape so as to enable an attachment member 16a-c to couple and rotate adjacent the face thereof in a smooth, substantially seamless fashion.

Split neck 42 may be substantially similar to or identical to the split necks disclosed in U.S. Pat. No. 6,711,785 which is incorporated herein by reference, and the applications incorporated by reference therein. Coupler 14 selectively couples to a selected attachment member 16a, 16b or 16c by coupling split neck 42 to a respective base member 46a-c as disclosed in U.S. Pat. No. 6,711,785 which is incorporated herein by reference, and the applications incorporated by reference therein.

Split neck 42 can snap fit within and rotate within each of a selected base members 46a-c in a male/female mating relationship. Each base member 46a-c is configured to selectively mate with split neck 42 of coupler 42 such that each of the attachment members 16a-c can be selectively, rotatably coupled to coupler 14 and can be selectively detached therefrom, as reflected in FIG. 2 and as disclosed in the aforementioned patent. Specifically, the outer skirt 47 of neck 42 passes through a portion of base 46a-c, then movably rests on a circular, internal ridge within each base 46a-c, such that the ridge rotatably retains neck 42 within each base 46a-c. Neck 42 can also be pulled out of each base 46a-c by applying sufficient force and/or twisting or bending between the neck and a respective base such that the skirt of the neck 42 moves past the circular internal ridge in the base.

As shown in FIG. 2, substantially oval-shaped loop member 44 is configured such that coupler 14 conveniently hangs downwardly from lanyard strap 20 when coupler 14 is in a downward position and such that sleeve 12 conveniently, symmetrically hangs downwardly from coupler 14 when sleeve 12 is in a downward position with respect to coupler 14. In one embodiment, lanyard 20 conveniently hangs on the elongate portion 48 of loop member 44 when sleeve 12 is in a downward position, as shown in FIG. 2 such that sleeve 12 hangs in a balanced, symmetrical position with respect to coupler 14.

The side members 50a,b of loop member 44 are sufficiently sloped upwardly with respect to elongate member 48 such that lanyard 20 hangs downwardly from coupler 14 and such that the longitudinal axis 64 of sleeve 12 is substantially parallel to elongate member 48. This dynamic of providing parallelism between longitudinal axis 22 and elongate member 48 enables system 10 to hang in a symmetrical and aesthetically pleasing manner from a store shelf, belt loop, or a back pack or other accessory.

Coupler 14 may be comprised of a variety of different materials such as plastics and other durable light weight readily formable or moldable materials. Similarly, attachment members 16a-c may be comprised of the same or similar materials as coupler 14.

FIG. 2 shows system 10 with hook 16b coupled to a belt loop of the pants of a user for convenient access to container 18 during recreation, work, or another activity. Sleeve 12 has a first end 60a, a second end 60b, and a center 62 located therebetween. A broken, longitudinal line 64 identifies a longitudinal axis of sleeve 12. Transverse broken lines 66a, 66b identify the boundaries of the complete cylindrical portion 68 of sleeve 12. Additional end portions 70a, 70b of sleeve 12, which do not form a complete cylinder, extend integrally from complete cylindrical portion 68. Additional end portions 70a, 70b are configured as slanting portions.

Each of the additional end portions 70a, 70b of sleeve 12 comprise material that extends significantly away from the complete cylindrical portion 68. Thus, sleeve 12 comprises an elongate sleeve comprising a complete hollow cylindrical portion 68 and opposing additional sleeve end portions 70a, 70b which do not form complete cylinders, but extend from portion 68 on opposing ends thereof.

At each end 60a, 60b thereof, sleeve 12 has (i) a first, lower terminus 72a, 72b, which is a terminal portion of sleeve 12, and (ii) a second, upper terminus, 74a, 74b. Each first terminus 72a, 72b extends significantly further away from center 62 of sleeve 12 than each second terminus 74a, 74b such that each first terminus 72a, 72b can cover a portion of an object, e.g, container 18, while another portion of container 18 is exposed outside sleeve 12 and can be contacted by a user.

This dynamic provides a variety of different advantages, such as the ability to cover a portion of an object while leaving another portion uncovered. This enables each sleeve end 60a, 60b to provide protection for the covered, non-exposed portion of an object such as a container 18, while enabling a user to contact an exposed portion of the container.

Thus, in one embodiment a portion of a container 18 is protected from environmental factors such as jostling and contact within a user's pocket, or contact by other objects contacted by a user wearing system 10 or having system 10 mounted on an accessory such as a back pack or clothing. However, the exposed, non-covered portion of container 18a can nevertheless be contacted by the user, e.g. by the user's fingers, thus the container 18 may still be accessed by the user. As shown in FIG. 2, sleeve 12 may cover a portion of both the lid 86 and threads 80 of a container 18.

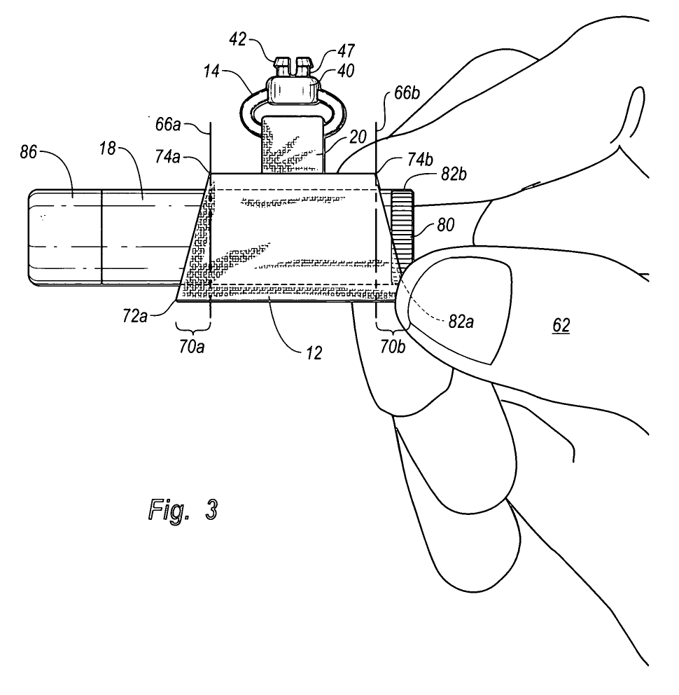

In another embodiment, sleeve 12 only partially covers either the threads 80 or lid 86 of container 18. For example, FIG. 3 is another side view of the holding sleeve assembly 11 of FIG. 1 with lip balm container 18 or other container having adjustment threads 80 mounted in sleeve 12 such that additional material 70b having terminus 72b contacts and covers a lower portion 82a of threads 80. This protects threads 80 from inadvertently moving due to environmental factors. Upper terminus 74b does not contact threads 80 such that threads 80 can be grasped and moved by a user when the user desires to move lip balm out of container 18.

In FIG. 3 container 18 has an exposed portion 82b and a covered portion 82a of adjustment threads. Adjustment threads 80 are used to adjust the position of the lip balm within container 18 as commonly performed in the lip balm container art. Since covered, unexposed portion 82a cannot be inadvertently moved by objects within a rustling pants pocket or within the environment surrounding a moving belt loop or back pack. Furthermore, portion 72b of sleeve 12 can contact threads 80, thereby resisting movement of threads 80 by minor unintentional environmental factors contacting exposed portion 82b. However, a user can move threads 80 by applying sufficient force against exposed portion 82b to overcome the frictional gripping forces of portion 72b of sleeve 12. Thus, an active user who is constantly jostling system 10 with container 18 therein is less likely to inadvertently move threads 80 than when threads 80 are entirely exposed to the environment, but can move threads 80 when desired.

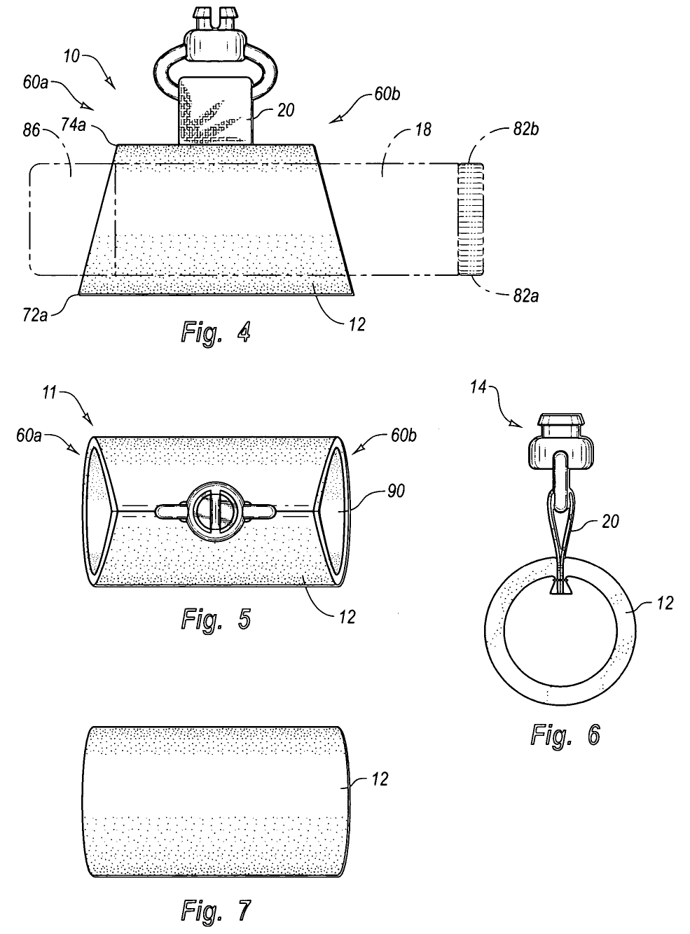

As yet another example of the advantages of sleeve 12, FIG. 4 is another side view of the holding sleeve assembly 11 of FIG. 1. The lid 86 of container 18 is partially covered by sleeve 12. The lower terminus 72a of an end 60a contacts lid 86, so as to protect lid 86 and possibly prevent it from inadvertently moving due to environmental factors. An upper terminus 74a does not contact lid 86 such that lid 86 can be grasped and moved by a user. In one embodiment, the opposing side view is a mirror image of the side view shown in FIG. 4.

Sleeve 12 may be comprised of a variety of different materials such as a resilient material that resiliently expands to receive an object such as container 18 than resiliently encloses the object such that the object does not fall out of the grip of sleeve 12 despite rugged exposure to the environment while walking, hiking, driving, biking, running, or a variety of different environmental factors. In one embodiment, sleeve 12 comprises a neoprene material, a neoprene based fabric material, a neoprene and nylon and/or polyester laminate material, or other material that is resiliently expandable so as to resiliently retain an object therein.

As shown in FIGS. 4-6, coupler 12 is connected to sleeve 12 by lanyard 20. Lanyard 20 may be comprised of a fabric material or any other material that attaches coupler 14 to sleeve 12. In one embodiment, lanyard 20 comprises a strap having opposing first and second ends that are sandwiched between opposing adjoined ends of sleeve material. This may be performed by providing a flat piece of material used to form sleeve, then attaching lanyard 18 thereto with the lanyard extended through loop portion 44 of coupler 14 and with the ends of the lanyard 20 sewn into the adjoined ends of the sleeve material, thereby forming sleeve with lanyard 20 sewn thereto.

However, a variety of materials may be used to perform the function of sleeve 12, lanyard 20, coupler 14 and attachments 16a-c. FIG. 5 shows a top view of system 10. FIG. 6 shows an end view of system 10, the opposing end view being the mirror image thereof. FIGS. 5 and 6 show that longitudinal bore 90 extends from first end 60a to second end 60b of sleeve 12. FIG. 7 shows a bottom view of system 10.

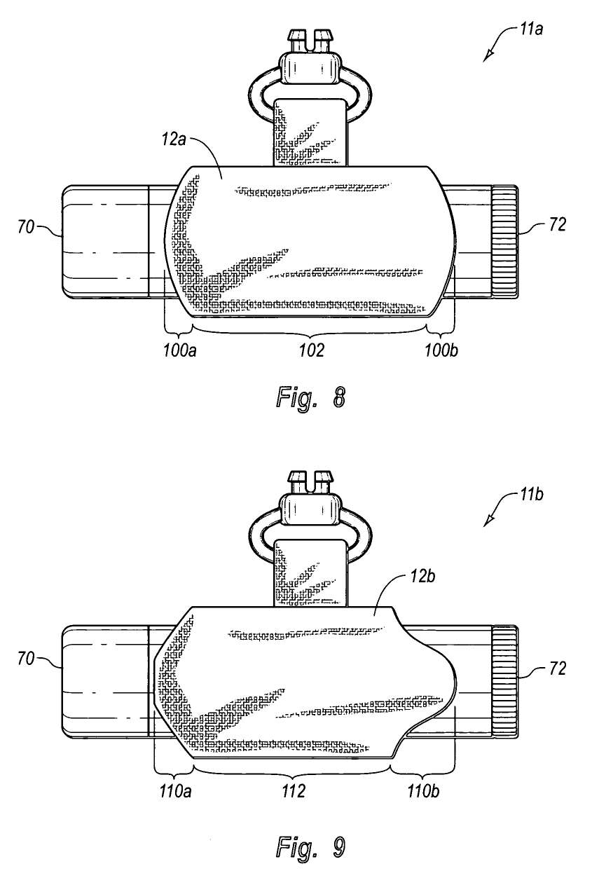

FIG. 8 shows a view of an alternate sleeve 12a which is useful in alternate system 11a and has the same characteristics of system 11 except that it has alternate end portions 100a, 100b extending from the complete cylindrical portion 102 thereof. End portions 100a, 100b are configured as curved end portions, rather than as the slanting portions shown in FIGS. 1-7.

FIG. 9 shows a view of an alternate sleeve 12b which is useful in alternate system 11b and has the same characteristics of system 11 except that it has alternate end portions 110a, 110b extending from the complete cylindrical portion 112 thereof. End portions 110a, 110b are configured as upper and lower slanted portions (110a), and alternately curved portions (110b), respectively, rather than as the slanting portions shown in FIGS. 1-7.

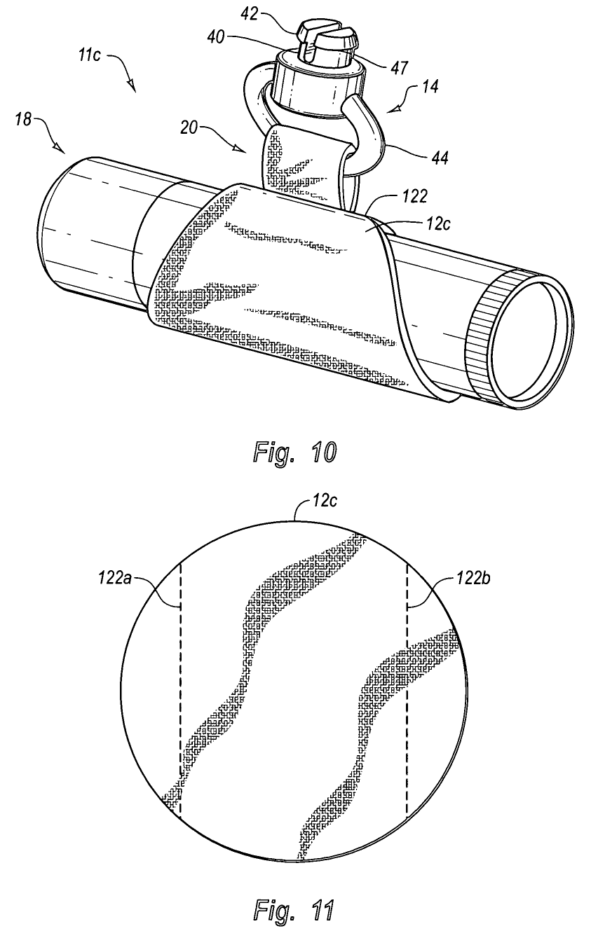

FIGS. 10-15 represent another embodiment of the present invention where holding sleeve 12c is formed from a circular piece of material. Utilizing a circular piece of material provides many benefits. When the circular piece is appropriately fabricated to form holding sleeve 12c, the circular shape of the material naturally provides for curved ends. Further, it provides for a holding sleeve that is aesthetically pleasing to users and quite different in shape than traditional retention cylinders available or known in the art. Also, it is very convenient to sew one circular end to another and achieve a sleeve having one terminus extending substantially farther from the center than another terminus

FIG. 10 is a perspective view of a holding sleeve assembly 11c of the present invention. Holding sleeve assembly 11c comprises: (i) a holding sleeve 12c configured to selectively receive and retain an object therein; and (ii) a coupler 14 (e.g., the same coupler disclosed with respect to FIGS. 1-9) connected to holding sleeve 12c. Coupler 14 is connected to sleeve 12c through a connector 20 of holding sleeve assembly 11c. Connector 20 may be in the form of a variety of different connectors. In one embodiment, connector 20 comprises a lanyard 20 having first and second opposing ends. The opposing ends of the lanyard 20 may be sewn into the seam of sleeve 12c.

As indicated above, coupler 14, also referred to as a lanyard connector, can be conveniently, selectively, rotatably coupled to one of a variety of different attachment members, examples of which are shown at 16a-c in FIG. 1.

FIG. 11 shows holding sleeve 12c in a prefabricated configuration. In this embodiment, holding sleeve 12c comprises a circular piece of material including an imaginary first seam line 122a and an opposing and substantially parallel imaginary second seam line 122b. First and second lines 122a,b provide an indicator through which a stitch can be placed to facilitate fabrication of holding sleeve 12c.

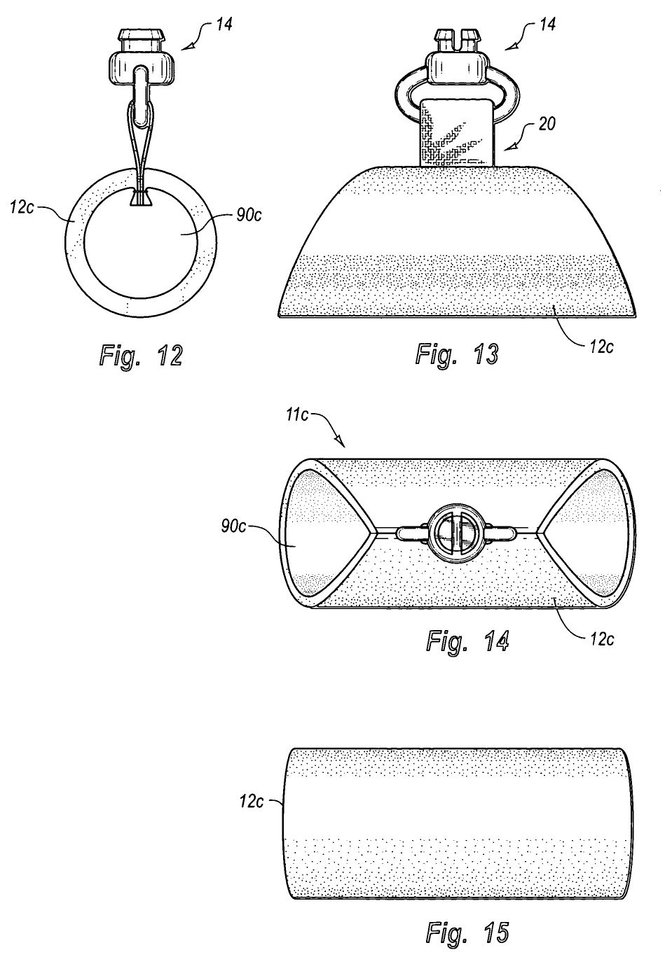

Holding sleeve 12c is initially formed by stamping out a circular piece of material and providing the material with seam lines 122a and 122b. Seam lines 122a,b are substantially parallel to and positioned apart from each other in order to create a holding sleeve 12c of appropriate diameter for a general object to be received and stored therein. Next, the circular piece is folded in half so that seam lines 122a,b match and abut each other and a stitch in provided through the material along seam lines 122a,b. In one embodiment, a lanyard with a coupler 14 mounted thereon may be incorporated into the holding sleeve 12c by placing opposing ends of the lanyard in between abutting seam lines 122a,b prior to stitching, and thereafter sewing a stitch or seam congruent with seam lines 122a,b. Once the stitch is placed through the material, the sleeve is turned inside out to form holding sleeve 12c as shown in FIG. 12. It is appreciated that differing sizes of circular pieces and locations of seam lines may be utilized to facilitate retainment of various objects of differing sizes and shapes.

FIG. 12 shows an end view of holding sleeve 12c, the opposing end view being a mirror image thereof. FIG. 13 shows a side view of holding sleeve 12c, the opposing side view being the mirror image thereof. FIG. 14 illustrates a top view of holding sleeve 12c. FIG. 15 shows a bottom view of holding sleeve 12c.

In one embodiment, the attachment member 16b of FIG. 2 is linked to the sleeve 12 through coupler 14, wherein the coupler 14 is connected to sleeve 12 and coupled to attachment member 16b. In another embodiment, attachment member 16b is linked to sleeve 12 by being directly connected to sleeve by being attached to lanyard 20 or, optionally, by being sewn into the seam of sleeve 12.

In one preferred embodiment of the present invention, one terminus of the holding sleeve extends significantly further away from the center than another terminus. For example, in one embodiment, extending significantly further away may be extending more than about one eighth (⅛) of an inch further away. Thus, end 70a may extend more than about one eighth (⅛) of an inch away from transverse line 66a, for example. In another embodiment, extending significantly further away may be extending at least about three sixteenths ( 3/16) of an inch further away. In another embodiment, extending significantly further away may be extending at least about one fourth (¼) of an inch further away. In another embodiment, extending significantly further away may be extending at least about one half (½) of an inch further away.

Thus, in one embodiment, the first terminus extends more than about one eighth of an inch further away from the center of the sleeve than the second terminus. In another embodiment, the first terminus extends at least about three sixteenths of an inch further away from the center of the sleeve than the second terminus. In another embodiment, the first terminus extends at least about one fourth of an inch further away from the center of the sleeve than the second terminus. In another embodiment, the first terminus extends at least approximately one half of an inch further away from the center of the sleeve than the second terminus. In another embodiment, the first terminus extends at least one half of an inch further away from the center of the sleeve than the second terminus. In one embodiment, the first terminus extends at least about five eighths of an inch further away from the center of the sleeve than the second terminus.

As shown in each of the FIGS. 1-15, the material used to form the sleeve of the present invention in one embodiment has a non-parallelogram configuration. This enables the convenient formation of a sleeve such that one terminus extends further from the center of the sleeve than another terminus. Examples of such non-parallelogram configurations which conveniently form such sleeves include the circular shape, as shown in FIG. 11. In one embodiment, a hexagonal shaped material is employed to form the sleeve 12 of FIG. 1.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A holding sleeve system comprising:
a holding sleeve configured to receive a first object therein;
a coupler connected to the holding sleeve; and
an attachment member configured to selectively couple to the coupler, the attachment member configured to selectively couple to a second object.

2. An system as recited in claim 1, wherein the holding sleeve has a center and first and second ends, wherein the first end has a portion thereof that extends significantly further from the center than another portion thereof.

3. An system as recited in claim 1, wherein the holding sleeve has a center and first and second ends, wherein the first end has a portion thereof that extends significantly further from the center than another portion thereof, and wherein the second end has a portion thereof that extends significantly further from the center than another portion thereof

4. An system as recited in claim 1, wherein the holding sleeve comprises a lanyard that connects the holding sleeve to the coupler.

5. A system as recited in claim 4, wherein the lanyard in mounted in a center of the sleeve.

6. An system as recited in claim 1, wherein the attachment member comprises a clip that can be selectively coupled to another object.

7. An system as recited in claim 1, wherein the coupler comprises a body and a loop member coupled thereto, the lanyard connecting the loop member to the sleeve.

8. An system as recited in claim 7, wherein a longitudinal axis of the sleeve is substantially parallel to an elongate portion of the loop member when the sleeve hangs downwardly from the coupler.

9. An system as recited in claim 1, wherein the sleeve has at least one slanted end.

10. An system as recited in claim 1, wherein the sleeve has first and second slanted ends.

11. An system as recited in claim 1, wherein the first object is a lip balm container and the second object is a belt loop.

12. A system as recited in claim 1, wherein the sleeve comprises a circular piece of material.

13. A holding sleeve system, comprising:
a sleeve having a longitudinal axis, the sleeve further having a first end, a second end, a center located between the first end and the second end, and a longitudinal bore extending along the longitudinal axis from the first end to the second end, wherein the first end of the sleeve has
(a) a first terminus; and
(b) a second terminus, the first terminus extending significantly further away from the center of the sleeve than the second terminus, such that the first terminus of the first end can cover a portion of a first object while another portion of the first object is exposed outside the sleeve and can be contacted by a user; and
an attachment member linked to the sleeve, the attachment member selectively coupling to a second object.

14. An system as recited in claim 13, wherein the attachment member is linked directly to the sleeve.

15. An system as recited in claim 13, wherein the attachment member is linked to the sleeve by having a coupler coupled to the attachment, and by having a lanyard that connects the coupler to the sleeve.

16. An system as recited in claim 13, wherein the attachment member is linked to the sleeve by an indirect coupling to the sleeve.

17. An system as recited in claim 16, wherein the indirect coupling comprises a coupler and lanyard connected to each other so as to couple the sleeve to the attachment member.

18. A system as recited in claim 13, wherein the sleeve comprises a circular piece of material.

19. A system as recited in claim 13, wherein the first terminus extends at least one fourth of an inch further away from the center of the sleeve than the second terminus.

20. A system as recited in claim 13, wherein the first terminus extends more than about one eighth of an inch further away from the center of the sleeve than the second terminus.

21. A system as recited in claim 13, wherein the first terminus extends at least about three sixteenths of an inch further away from the center of the sleeve than the second terminus.

22. A system as recited in claim 13, wherein the first terminus extends at least about one fourth of an inch further away from the center of the sleeve than the second terminus.

23. A system as recited in claim 13, wherein the first terminus extends at least approximately one half of an inch further away from the center of the sleeve than the second terminus.

24. A system as recited in claim 13, wherein the first terminus extends at least one half of an inch further away from the center of the sleeve than the second terminus.

25. A holding sleeve system comprising:
a sleeve having a center and first and second ends, at least one end having a portion thereof that extends further from the center than another portion thereof; and
an attachment member linked to the sleeve, the attachment member being linked to the sleeve by a coupler that is connected to the sleeve by a lanyard that is connected to the sleeve, wherein a threaded lip balm container is selectively retained within the sleeve such that a portion of an end of the lip balm container is contained within the sleeve while another portion of said end of said lip balm container is not contained within the sleeve.

26. An system as recited in claim 25, wherein the coupler comprises a body, a looped member, a looped member coupled to the body, and a connector coupled to an opposing end of the body such that the attachment member can be selectively coupled to the coupler.

27. An system as recited in claim 25, wherein the loop member comprises first and second side portions and an elongate member coupled to the first and second side portions such that the loop member has a substantially oval shape.

28. A system as recited in claim 25, wherein the sleeve comprises a circular piece of material.

29. A holding sleeve system, comprising:
a sleeve having a longitudinal axis, the sleeve further having a first end, a second end, a center located between the first end and the second end, and a longitudinal bore extending along the longitudinal axis from the first end to the second end, wherein the first end of the sleeve has
(a) a first terminus; and
(b) a second terminus, the first terminus extending significantly further away from the center of the sleeve than the second terminus, such that the first terminus of the first end can cover a portion of a first object while another portion of the first object is exposed outside the sleeve and can be contacted by a user;
a coupler connected to the sleeve by a lanyard, the lanyard being mounted in the center of the sleeve; and
at least one attachment member selectively, rotatably coupled to the coupler, the attachment member selectively coupling to a second object.

30. A holding sleeve system as recited in claim 29, wherein the attachment member is linked to the sleeve by a coupler selectively coupled to the attachment, the coupler being attached to the sleeve.

31. A holding sleeve system as recited in claim 30, wherein a lanyard couples the coupler to the sleeve.

32. A system as recited in claim 30, further comprising a second attachment member selectively rotatably coupled to the coupler, such that a variety of different attachment members may be coupled to the coupler.

33. A system as recited in claim 29, wherein the first terminus extends at least about one eighth of an inch further away from the center of the sleeve than the second terminus.

34. A system as recited in claim 29, wherein the first terminus extends at least approximately one fourth of an inch further away from the center of the sleeve than the second terminus.

35. A system as recited in claim 29, wherein the first terminus extends at least approximately one half of an inch further away from the center of the sleeve than the second terminus.

36. A holding sleeve system, comprising:
a sleeve having a longitudinal axis, the sleeve further having a first end, a second end, a center located between the first end and the second end, and a longitudinal bore extending along the longitudinal axis from the first end to the second end, wherein the first end of the sleeve has
(a) a first terminus; and
(b) a second terminus, wherein the sleeve comprises a material having a non-parallelogram configuration, such that the first terminus of the first end can cover a portion of a first object while another portion of the first object is exposed outside the sleeve and can be contacted by a user; and
an attachment member linked to the sleeve, the attachment member selectively coupling to a second object.

37. A system of claim 36, wherein the non-parallelogram configuration is a circular configuration.

38. A system as recited in claim 36, wherein the first terminus extends at least about five eighths of an inch further away from the center of the sleeve than the second terminus.

39. A system of claim 36, wherein the non-parallelogram configuration is a hexagon configuration.
